(19) United States
(12) Patent Application Publication
(10) Pub. No.: US 2005/0153864 A1
(43) Pub. Date: Jul. 14, 2005

(54) Tablets with improved resistance to breakage

(75) Inventor: Francesc Corominas, Brussels (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/034,149

(22) Filed: Jan. 12, 2005

(30) Foreign Application Priority Data
Jan. 12, 2004 (EP) 04447008.6

(51) Int. Cl. C11D 17/00

(52) U.S. Cl. 510/446

(57) ABSTRACT

The invention relates to a process for making a detergent tablet, comprising the steps of: (a) selecting a binder from: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof, (b) heating the binder to above its melting point to form a molten binder; (c) applying the molten binder to a base powder comprising a premix of detergent components, to form a detergent composition; and (d) forming the detergent composition into tablets. The present invention is further directed to a tablet composition obtainable by such process and to the use of such a binder, in its molten form for improving the resistance to breakage of a detergent tablet.

### FIELD OF THE INVENTION

The present invention relates to compositions in form of tablets, especially to tablets for a laundry or an automatic dishwashing operation, having improved resistance to breakage. Such tablets are obtainable by a process whereby a specific binder is applied in molten form to a base powder.

### BACKGROUND OF THE INVENTION

Compositions in form of tablets, e.g., especially for a laundry or an automatic dishwashing operation, become increasingly popular with consumers as they offer simple dosing, easy storage and handling. Also for detergent manufacturers, tablet compositions have many benefits such as reduced transportation costs, handling costs and storage costs.

However, a problem which constantly arises when using tablet compositions is their low dimensional stability and breaking strength and their often insufficient stability against abrasion. Tablet compositions are often insufficiently adapted to the demands of packaging, shipment and handling, i.e., when they are dropped or eroded. Thus, broken tablet edges and visible abrasion compromises the appearance of the tablets or even lead to the tablet structure being completely destroyed.

One option to overcome this issue is to use relatively high pressures when compressing the particulate materials forming the tablet. However, this leads to a severe densification of the tablet components and often to a poor and/or delayed disintegration of the tablet in the wash liquor with all drawbacks associated to that, such as reduced cleaning performance and others. Tablets with poor disintegration profile cannot be used in domestic washing machines via the drawer, since the tablets do not disintegrate fast enough into secondary particles sufficiently small in size to be rinsed out of the detergent drawer into the washing drums.

Another approach to increase the stability of tablet compositions is the use of a binder. Detergent tablets can be prepared by contacting a compact detergent powder with a binder and then tableting the powder to form a detergent tablet. The binder has a cohesive effect on the detergent powder and allows the application of less high pressures when forming the detergent tablet. EP 971 028 (P&G, published Jan. 12, 2000) discloses a tablet formed by compressing conventional detergent ingredients with a binder such as alkali metal C₃-C₈ alkyl- and dialkylaryl sulfonates. The most commonly used binder material is polyethylene glycol (PEG). PEG adequately binds the compact detergent powder. EP 1 352 951 (P&G, published Oct. 15, 2003) discloses a tablet detergent composition with a spray-on binder system comprising PEG. Also sugars have been used as binders. EP 1 138 756 (Henkel, published Oct. 4, 2001) discloses sugar binders which are added as a dry-add to a base-powder. The resulting mixture is granulated and subsequently compressed to form the detergent tablet. DE 101 25 441 (Henkel, published Dec. 5, 2002) exemplifies sugar-containing premixes which are compressed and subsequently heated. U.S. Pat. No. 4,642,197 (Henkel, published Feb. 10, 1987) describes an 70% aqueous solution of sorbitol which is sprayed onto a base powder before the tablet is formed by compression.

In view of current high demands on quick handling and transportation, tablets with more physical robustness are required. It is therefore an object of the present invention to provide a tablet composition with improved physical integrity, e.g., with increased resistance to breakage, whilst keeping excellent dissolution and dispensing profiles.

The inventors have found that a tablet obtainable by a process in which a specific binder is applied in molten form to a base powder, demonstrates such improved resistance to breakage while maintaining excellent dissolution and dispensing profiles.

Another advantage of the present invention is, that tablets with excellent resistance to breakage can be produced in a wider range of density than what can be achieved with regular binders. This provides tablets with improved dissolution profile.

### SUMMARY OF THE INVENTION

In a first embodiment of the present invention, there is provided a process for making a detergent tablet, comprising the steps of:
(a) selecting a binder from: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof;
(b) heating the binder to above its melting point to form a molten binder;
(c) applying the molten binder to a base powder comprising a premix of detergent components, to form a detergent composition; and
(d) forming the detergent composition into tablets.

In a second embodiment of the present invention, there is provided a tablet composition obtainable by the above process.

In a third embodiment of the present invention, there is provided the use of a binder in its molten form for improving the resistance to breakage of detergent tablets whereby the binder is selected from: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof.

### DETAILED DESCRIPTION OF THE INVENTION

Except as otherwise specifically noted, all amounts including quantities, percentages, portions, and proportions, are understood to be modified by the word “about”, and amounts are not intended to indicate significant digits.

When using the term “alkoxylation” within the present invention, any linear, branched, substituted or unsubstituted alkoxy group is included, typically C₁ to C₁₀ alkoxy groups, and mixtures thereof, are used. Preferred alkoxy groups are selected from ethoxy, propoxy, butoxy, and mixtures thereof, most preferred alkoxy group is ethoxy.

When using the term “unsubstituted” within the present invention, it is meant that the hydrocarbon chain contains only carbon and hydrogen atoms and no other hetero-atoms except, where appropriate, for the hydroxy group making up the alcohol functionality.

When using the term “substituted” within the present invention, it is meant that the hydrocarbon chain also contains other atoms than carbon and hydrogen atoms. Substituted hydrocarbon chains may also contain hetero-atoms such as one or more nitrogen atoms, phosphor atoms, sulfur atoms, fluorine atoms, chlorine atoms, bromine atoms, iodine atoms, and any other atom of the periodic table of the elements.

The Process

The process of the present invention, herein referred to as “process”, is used to prepare a composition in the form of a tablet. It comprises the steps of: (a) selecting a binder from: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof, (b) heating the binder to above its melting point to form a molten binder; (c) applying the molten binder to a base powder comprising a premix of detergent components, to form a detergent composition; and (d) forming the detergent composition into tablets.

It is an essential element of the present invention that the binder system is heated up to a temperature above its melting point to form a molten binder system before applying the molten binder system to the base powder; using any heating system.

The molten binder system is contacted to the base powder to form a composition in any suitable manner. Typically, the molten binder system is contacted to the base powder at a temperature of at least 45° C., preferably from 55° C. to 150° C., and more preferably from 70° C. to 120° C. The molten binder system is contacted to a base powder, typically by spraying the molten binder system onto the base powder. Typically this process step is carried out using a spray-on arm, preferably using a spray-on arm in a rotating spray drum. Preferred spray-on arms comprise at least one nozzle, preferably more than one nozzle for example from 10 to 18 nozzles, connected to a low pressure hot air line. By low pressure it is meant a pressure below 700 kNm⁻², preferably a pressure between 100 kNm⁻² to 600 kNm⁻², more preferably from 150 kNm⁻² to 550 kNm⁻² and most preferably from 200 kNm⁻² to 450 kNm⁻². The hot air is typically at a temperature of at least 45° C., preferably from 55° C. to 160° C., and more preferably from 70° C. to 120 ° C.

This composition is then tableted, typically by compression or compaction to form a detergent tablet. This compression/compaction step is usually carried out in a conventional tablet press, for example, using a standard single stroke press or a rotary press such as Courtoy, Korch, Manesty or Bonals.

Preferably, this compression/compaction step typically uses a force of less than 100,000 N, preferably less than 50,000 N, or even less than 5,000 N, or even less than 3,000 N. Most preferably the process of the present invention comprises a step of compressing or compacting the composition, using a force of less than 2,500 N. Detergent tablets, suitable for use in automatic dish washing applications, may be compressed or compacted using a force higher than 2,500 N if required. Other compaction process steps may be used including, for example, briquetting and/or extrusion.

The detergent tablet typically has a diameter of between 20 mm and 60 mm, and typically having a weight of from 10 g to 100 g. The ratio of tablet height to tablet width is typically greater than 1:3. The tablet typically has a density of at least 900 g/l, preferably at least 950 g/l, and preferably less than 2,000 g/l, more preferably less than 1,500 g/l, most preferably less than 1,200 g/l.

In a preferred embodiment of the present invention, the detergent tablet is typically coated with a coating material. The coating material is typically contacted to the rest of the detergent tablet at a temperature of at least 40° C., preferably of at least 100° C., more preferably at least 140° C., and most preferably at a temperature of from 150° C. to 170° C. Preferred coating materials comprise a combination of (i) a dicarboxylic acid, and (ii) an ion exchange resin or a clay. A preferred ion exchange resin is PG2000Ca supplied by Purolite. Preferred dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid, derivatives thereof, or combinations thereof, most preferred is adipic acid. Preferably, the weight ratio of components (i) to (ii) above is in the range of from 40:1 to 10:1, and more preferably of from 30:1 to 20:1. The coating material, if present, typically comprises from 1% to 10%, and more preferably from 4% to 8% by weight of the detergent tablet.

In a preferred embodiment of the present invention, the detergent tablet is a multi-layer detergent tablet wherein the different layers can either have the same or different colors. Multi-layer tablets having 2 or 3 layer are particularly preferred. Single- and multi-layer tablets having exaltations and/or cavities and/or holes in all sorts of geometrical forms are also included in the present invention. Particularly preferred are tablets in which embedded geometrical shapes such as hemispheres protrude from the surface of the tablet.

The binder is typically present at a level of from 0.1% to 80% by weight, preferably from 0.5% to 30% by weight, more preferably from 1.0% to 10%, and most preferably from 1.25% to 5% by weight of the detergent tablet. The base powder is typically present at a level of from 20% to 99.9% by weight, preferably from 35% to 99% by weight, more preferably from 50% to 98.5%, and most preferably from 55 to 95% by weight of the detergent tablet.

Binder

The binder in its molten form may comprises some undissolved matter, but the majority of the binder is liquid in molten form at the processing conditions described hereinabove, for example at least 80 wt %, or at least 85 wt %, or at least 90 wt %, or at least 95 wt % of the binder is liquid at the processing conditions described hereinabove. Preferably all of the binder is liquid at the processing conditions described hereinabove.

Binders suitable for use in the processes of the present invention are selected from: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof.

Preferred binders are selected from: sorbitol; xylitol; erythritol; nonylphenol, 50 ethoxylate (commercially available as Berol 291 ex Akzo Nobel); C₁₆-C₂₂ alcohol, 80 ethoxylate (commercially available as Berol 08 ex Akzo Nobel); castor oil, 160 ethoxylate (commercially available as Berol 198 ex Akzo Nobel); glyceryl tripalmitin ester (commercially available ex Sigma-Aldrich); stearic acid (commercially available ex Sigma-Aidrich); C₁₆-C₁₈ alcohol, 80 ethoxylate (commercially available ex Clariant); C₁₃-C₁₅-alcohol, 30 ethoxylate (commercially available as Lutensol AO30 ex BASF), and mixtures thereof. The most preferred binder is sorbitol.

The binder of the present invention may optionally be mixed with one or more additional compounds so forming a binder system. Such additional compounds may be selected from a wide variety of different ingredients. Suitable ingredients can be selected from viscosity modifiers, building agents, dissolution aids, surfactants, fabric softening agents, alkalinity sources, colorants, perfumes, lime soap dispersants, organic polymeric compounds including polymeric dye transfer inhibiting agents, crystal growth inhibitors, heavy metal ion sequestrants, metal ion salts, corrosion inhibitors, softening agents, optical brighteners, and combinations thereof. Preferred ingredients are viscosity modifiers, dissolution aids, surfactants, alkalinity sources, colorants, perfumes, crystal growth inhibitors, and combinations thereof.

A more preferred additional component is a viscosity modifier. If present, the viscosity modifier may be present from 1.0% to 95%, preferably from 2.5% to 50%, more preferably from 5.0% to 15%, and most preferably from 7.5% to 12.5% by weight of the binder system. Suitable viscosity modifiers can be aqueous or non-aqueous; and can include water alone or organic solvents alone and/or combinations thereof. Preferred organic solvents include linear, branched, cyclic, substituted or unsubstituted monohydric alcohols, dihydric alcohols, polyhydric alcohols, ethers, alkoxylated ethers, low-viscosity silicone-containing solvents, low-melting nonionic, optionally alkoxylated, surfactants having a melting point below 45° C., and combinations thereof. Preferred are glycerin, glycols, linear, branched, cyclic, substituted or unsubstituted polyalkylene glycols such as polyalkylene glycols, dialkylene glycol mono C₁-C₈ ethers, C₅-C₁₅ nonionic surfactants with 1 to 10 equivalents of ethoxylation, monohydric alcohols, dihydric alcohols, and combinations thereof. Even more preferred are diethylene glycol mono ethyl ether, diethylene glycol mono propyl ether, diethylene glycol mono butyl ether, and combinations thereof. Highly preferred are lower linear, branched, cyclic, substituted or unsubstituted aliphatic alcohols such as ethanol, propanol, butanol, isopropanol, and/or diols such as 1,2-propanediol, 1,3-propanediol, 1,6-hexandiol, 1,2-hexandiol, 2-ethyl-1,3-hexandiol, 2-methyl-2,4-pentandiol, 2,3,4-trimethyl-1,3-pentandiol, 1,4-bis(hydroxy-methyl)cyclohexane, and combinations thereof, optionally with dialkylene glycol mono C₁-C₈ ethers and/or glycols and/or water. Most preferred viscosity modifier is either water alone, or a 50:50 mixtures of water with either glycerin and/or C₁₂-C₁₅ nonionic surfactant with from 3 to 7 equivalents of ethoxylation and/or 1,2-propanediol, 1,3-propanediol, 1,6-hexandiol, 1,2-hexandiol, 2-ethyl-1,3-hexandiol, 2-methyl-2,4-pentandiol, 2,3,4-trimethyl-1,3-pentandiol, 1,4-bis(hydroxy)cyclohexane, and combinations thereof. When water is used as viscosity modifier, either alone or in combination with other viscosity modifiers, the total water content preferably does not exceed 20%, more preferably does not exceed 10%, and most preferably is between 3% to 7% by weight of the binder system. When water is used as viscosity modifier, it is no way intended to use an aqueous solution of one or more binders.

More preferably, the binder system comprises sorbitol and from 3% to 7% by weight of the binder system, of the viscosity modifier water.

The binder of the present invention can also be used for binding purposes in particle making processes, e.g., agglomeration, compaction, prill making, spray drying, extrusion.

Base Powder

The base powder typically comprises a wide variety of different ingredients, such as building agents, effervescent system, enzymes, dissolution aids, disintegrants, bleaching agents, suds supressors, surfactants (nonionic, anionic, cationic, amphoteric, and/or zwitterionic), fabric softening agents, alkalinity sources, colorants, perfumes, lime soap dispersants, organic polymeric compounds including polymeric dye transfer inhibiting agents, crystal growth inhibitors, anti-redeposition agents, soil release polymers, hydrotropes, fluorescents, heavy metal ion sequestrants, metal ion salts, enzyme stabilisers, corrosion inhibitors, softening agents, optical brighteners, and combinations thereof.

The base powder is typically a pre-formed detergent granule. The preformed detergent granule may be an agglomerated particle or in any other form. By agglomerated particle it is typically meant a particle which has already been agglomerated, and thus is already in an agglomerate form, prior to contacting the molten binder, as described hereinabove.

The average particle size of the base powder is typically from 100 μm to 2,000 μm, preferably from 200 μm, or from 300 μm, or from 400 μm, or from 500 μm and preferably to 1,800 μm, or to 1,500 μm, or to 1,200 μm, or to 1,000 μm, or to 800 μm, or to 700 μm. Most preferably, the average particle size of the base powder is from 400 μm to 700 μm.

The bulk density of the base powder is typically from 400 g/l to 1,200 g/l, preferably from 500 g/l to 950 g/l, more preferably from 600 g/l to 900 g/l, and most preferably from 650 g/l to 850 g/l.

Preferred optional ingredients are described in more detail hereinafter. All percentages given are on a weight basis of the whole detergent tablet unless specified.

Preferred Optional Ingredients

Builder Compound

The base powder herein preferably comprises a builder compound, typically present at a level of from 1% to 80% by weight, preferably from 10% to 70% by weight, most preferably from 20% to 60% by weight of the base powder.

Highly preferred builder compounds for use in the present invention are water-soluble phosphate builders. Specific examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from 6 to 21, and salts of phytic acid.

Examples of partially water soluble builders include the crystalline layered silicates as disclosed for example, in EP-A-0164514, DE-A-3417649 and DE-A-3742043.

Examples of largely water insoluble builders include the sodium aluminosilicates. Suitable aluminosilicates include the aluminosilicate zeolites having the unit cell formula Na_{z}[(AlO₂)_{z}(SiO₂)_{y}].H₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form.

Effervescent System

The base powder herein preferably comprises an effervescent system, typically present at a level of from 1% to 30% by weight, preferably from 5% to 25% by weight, most preferably from 10% to 20% by weight of the base powder.

Effervescent systems suitable herein include those derived by combining an acid source and a bicarbonate or carbonate, or by combining hydrogen peroxide and catalase, or any other combination of materials which release small bubbles of gas, e.g, carbon dioxide gas. The components of the effervescent system may be dispensed in combination to form the effervescence when they are mixed, or can be formulated together provided that conventional coatings or protection systems are used. Hydrogen peroxide and catalase are very mass efficient and can be at much lower levels with excellent results.

Surfactant

The base powder herein preferably comprises at least one surfactant, preferably two or more surfactants. The total surfactant concentration is typically from 1% to 80% by weight, preferably from 10% to 70% by weight, most preferably from 20% to 60% by weight of the base powder. Suitable surfactants are selected from anionic, cationic, nonionic ampholytic and zwitterionic surfactants and mixtures thereof.

A typical listing of anionic, nonionic, amphoteric and zwitterionic classes, and species of these surfactants, is given in U.S. Pat. No. 3,929,678 issued to Laughlin and Heuring on Dec. 30, 1975. A list of suitable cationic surfactants is given in U.S. Pat. No. 4,259,217 issued to Murphy on Mar. 31, 1981. A listing of surfactants typically included in laundry detergent compositions is given for example, in EP-A-0414 549 and PCT Applications No.s WO 93/08876 and WO 93/08874. Further suitable detergent active compounds are available and are fully described in WO 02/31100 published on Apr. 18, 2002 and assigned to P&G and in the literature, e.g., in “Surface-active agents and detergents”, Vol. I and II, by Schwartz, Perry and Berch.

Dissolution Aid

The base powder herein preferably comprises a dissolution aid, typically present at a level of from 0.01% to 10% by weight, preferably from 0.1% to 5% by weight, most preferably from 0.15% to 2.5% by weight of the base powder.

The dissolution aid may preferably comprise an organic sulfonated compound such as C₁-C₄ alk(en)yl sulfonic acids and C₁-C₄ alkyl-aryl sulfonic acids, or derivatives thereof, or salts thereof, or combinations thereof.

Preferably, the dissolution aid may comprise salts of aryl sulfonic acids, including alkali metal salts of benzoic acid, salicylic acid, benzenesulfonic acid, naphtoic acid, derivatives thereof and combinations thereof. Preferred examples of salts of aryl sulfonic acid are sodium, potassium, ammonium benzene sulfonate salts derived from toluene sulfonic acid, xylene sulfonic acid, cumene sulfonic acid, tetralin sulfonic acid, naphtalene sulfonic acid, methyl-naphtalene sulfonic acid, dimethyl-naphtalene sulfonic acid, trimethyl-naphtalene sulfonic acid. Preferred are sodium toluene sulfonate, sodium cumene sulfonate, sodium xylene sulfonate, derivatives thereof, and combinations thereof.

The dissolution aid may comprise salts of dialkyl benzene sulfonic acid such as salts of di-isopropyl benzene sulfonic acid, ethyl methyl benzene sulfonic acid, alkyl benzene sulfonic acid with a C₃-C₁₀, preferably C₄-C₉, linear or branched alkyl chain.

The dissolution aid may comprise a C₁-C₄ alcohol such as methanol, ethanol, propanol such as iso-propanol, and derivatives thereof, and combinations thereof, preferably ethanol and/or iso-propanol.

The dissolution aid may comprise a C₄-C₁₀ diol such as hexanediol and/or cyclohexanediol, preferably 1,6-hexanediol and/or 1,4-cyclohexanedimethanol.

The dissolution aid may comprise a compound comprising a chemical group of the following general formula

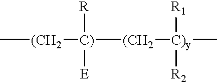

where E is a hydrophilic functional group, R is H or a C₁-C₁₀ alkyl group or a hydrophilic functional group, R₁ is H or a C₁-C₁₀ alkyl group or an aromatic group, R₂ is H or a cyclic alkyl or an aromatic group. The compound preferably have a weight average molecular weight of from 1,000 to 1,000,000.

The dissolution aid may comprise 5-carboxy-4-hexyl-2-cyclohexene-1-yl octanoic acid.

The dissolution aid may comprise a cationic compound. Preferably the dissolution aid comprises a cationic polymer, more preferably an ethoxylated cationic diamine. Preferred ethoxylated cationic dianines have the general formula;

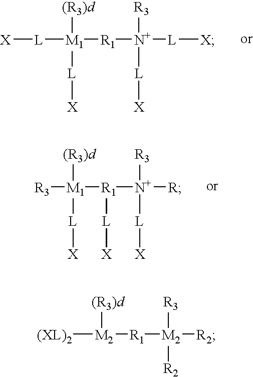

wherein; M₁ is an N⁺ or N group, preferably an N⁺ group; each M₂ is an N⁺ or N group, preferably an N⁺ group, and at least one M₂ is an N⁺ group; R is H or C₁-C₄ alkyl or hydroxyalkyl; R₁ is C₂-C₁₂ alkylene, hydroxyalkylene, alkenylene, arylene or alkarylene, or a C₂-C₃ oxyalkylene moiety having from 2 to 20 oxyalkylene units provided that no O—H binds are formed; each R₂ is C₁-C₄ alkyl or hydroxyalkyl, the moiety L—X or two R₂ together form the moiety (CH₂)ᵣ—A²—(CH₂)ₛ, wherein A² is O or CH₂, r is 1 or 2, s is 1 or 2, and r+s is 3 or 4; each R₃ is C₁-C₈ alkyl or hydroxyalkyl, benzyl, the moiety L—X, or two R₃ or one R₃ and one R₂ together form the moiety (CH₂)ᵣ—A²—(CH₂)ₛ, wherein A² is O or CH₂, r is 1 or 2, s is 1 or 2, and r+s is 3 or 4; X is a nonionic group selected from H, C₁-C₄ alkyl or hydroxyalkyl ester or ether groups and mixtures thereof, preferred esters and ethers are the acetate ester and methyl ether respectively; L is a hydrophilic chain which contains the polyoxyalkylene moiety {(R₆O)m(CH₂CH₂O)n} wherein R₆ is C₃-C₄ alkylene or hydroxyalkylene, m and n are numbers such that the moiety (CH₂CH₂O)ₙ comprises at least 50% by weight of the polyoxyalkylene moiety; d is 1 when M₂ is N⁺, and is 0 when M₂ is N; n is at least 6.

The positive charge of the N+ groups is offset by the appropriate number of counter anions. Suitable counter anions include Cl⁻, Br⁻, SO₃²⁻, SO₄²⁻, PO₄²⁻, MeOSO₃⁻ and the like. Particularly preferred are Cl⁻ and Br⁻.

A preferred ethoxylated cationic diamine suitable for use herein is known under the tradename as Lutensit K-HD 96 supplied by BASF.

Softening Ingredient

The base powder herein may optionally comprises a softening ingredient, typically present at a level of from 0.5% to 50% by weight, preferably from 1% to 30% by weight, most preferably from 5% to 20% by weight of the base powder.

The softening ingredients suitable for use herein, may be selected from any known ingredients that provides a fabric softening benefit, for example smectite clay.

The smectite clays used herein are typically commercially available. Such clays include, for example, montmorillonite, volchonskoite, nontronite, hectorite, saponite, sauconite, and vermiculite. The clays herein are available under various tradenames, for example, Thixogel #1® and Gelwhite GP® from Georgia Kaolin Co., Elizabeth, N.J.; Volclay BC® and Volclay #325®, from American Colloid Co., Skokie, Ill.; Black Hills Bentonite BH450®, from International Minerals and Chemicals; and Veegum Pro and Veegum F, from R. T. Vanderbilt. It is to be recognised that such smectite-type minerals obtained under the foregoing tradenames can comprise mixtures of the various discrete mineral entities. Such mixtures of the smectite minerals are suitable for use herein.

Smectite clays are disclosed in the U.S. Pat. Nos. 3,862,058, 3,948,790, 3,954,632 and 4,062,647. European Patents No.s EP-A-299,575 and EP-A-313,146 in the name of the Procter and Gamble Company describe suitable organic polymeric clay flocculating agents.

Enzymes

Where present, the enzymes are selected from cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase or mixtures thereof.

Preferred enzymes include protease, amylase, lipase, peroxidases, cutinase and/or cellulase in conjunction with one or more plant cell wall degrading enzymes.

The enzymes are normally incorporated in the detergent tablet at levels from 0.0001% to 2% of active enzyme by weight of the base powder. The enzymes can be added as separate single ingredients (prills, granulates, stabilized moltens, etc . . . containing one enzyme) or as mixtures of two or more enzymes (e.g. cogranulates).

Bleaching Agent

The base powder herein may optionally comprise materials selected from of catalytic metal complexes, activated peroxygen sources, bleach activators, bleach boosters, photobleaches, free radical initiators and hyohalite bleaches. Examples of suitable catalytic metal complexes include, but are not limited to, manganese-based catalysts such as Mn^{IV}₂ (u-O)₃(1,4,7-trimethyl-1,4,7-triazacyclononane)₂(PF₆)₂ disclosed in U.S. Pat. No. 5,576,282, cobalt based catalysts disclosed in U.S. Pat. No. 5,597,936 such as cobalt pentaamine acetate salts having the formula [Co(NH₃)₅OAc] T_{y}, wherein “OAc” represents an acetate moiety and “T_{y}” is an anion; transition metal complexes of a macropolycyclic rigid ligand—abreviated as “MRL”. Suitable metals in the MRLs include Mn, Fe, Co, Ni, Cu, Cr, V, Mo, W, Pd, and Ru in their various oxidation states. Examples of suitable MRLs include: Dichloro-5,12-diethyl-1,5,8,12-tetraazabicyclo[6.6.2]hexadecane Manganese(II), Dichloro-5,12-diethyl-1,5,8,12-tetraaza-bicyclo[6.6.2]hexadecane Manganese(III) Hexafluorophosphate and Dichloro-5-n-butyl-12-methyl-1,5,8,12-tetraaza-bicyclo[6.6.2]hexadecane Manganese(II). Suitable transition metal MRLs are readily prepared by known procedures, such as taught for example in WO 00/332601, and U.S. Pat. No. 6,225,464.

Suitable activated peroxygen sources include, but are not limited to, preformed peracids, a hydrogen peroxide source in combination with a bleach activator, or a mixture thereof. Suitable preformed peracids include, but are not limited to, compounds selected from percarboxylic acids and salts, percarbonic acids and salts, perimidic acids and salts, peroxymonosulfuric acids and salts, and mixtures thereof. Suitable sources of hydrogen peroxide include, but are not limited to, compounds selected from perborate compounds, percarbonate compounds, perphosphate compounds and mixtures thereof. Suitable types and levels of activated peroxygen sources are found in U.S. Pat. Nos. 5,576,282, 6,306,812 B1 and 6,326,348 B1 that are incorporated by reference.

Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate.

Suitable bleach boosters include, but are not limited to, those described U.S. Pat. No. 5,817,614

As a practical matter, and not by way of limitation, the base powder herein can be adjusted to provide on the order of at least one part per hundred million of catalytic metal complex in the aqueous washing. When present, hydrogen peroxide sources will typically be at levels of from about 1%, to about 30%, by weight of the base powder. If present, peracids or bleach activators will typically comprise from about 0.1% to about 60% by weight of the bleaching composition. As a practical matter, and not by way of limitation, the base powders herein can be adjusted to provide on the order of at least one part per hundred million of bleach booster in the aqueous washing.

Heavy Metal Ion Sequestrant

The base powder herein may contain as an optional component a heavy metal ion sequestrant. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 20%, preferably from 0.1% to 10%, more preferably from 0.25% to 7.5% and most preferably from 0.5% to 5% by weight of the base powder.

Water-soluble Sulfate Salt

The base powder herein optionally contains a water-soluble sulfate salt. Where present the water-soluble sulfate salt is at the level of from 0.1% to 40%, more preferably from 1% to 30%, most preferably from 5% to 25% by weight of the base powder.

The water-soluble sulfate salt may be essentially any salt of sulfate with any counter cation. Preferred salts are selected from the sulfates of the alkali and alkaline earth metals, particularly sodium sulfate.

Alkali Metal Silicate

An alkali metal silicate is a preferred component of base powder herein. A preferred alkali metal silicate is sodium silicate having an SiO₂:Na₂O ratio of from 1.8 to 3.0, preferably from 1.8 to 2.4, most preferably 2.0. Sodium silicate is preferably present at a level of less than 20%, preferably from 1% to 15%, most preferably from 3% to 12% by weight of SiO₂. The alkali metal silicate may be in the form of either the anhydrous salt or a hydrated salt.

Suds Suppressing System

The base powder herein, when formulated for use in machine washing compositions, preferably comprise a suds suppressing system present at a level of from 0.01% to 15%, preferably from 0.05% to 10%, most preferably from 0.1% to 5% by weight of the base powder.

Suitable suds suppressing systems for use herein may comprise essentially any known antifoam compound, including, for example silicone antifoam compounds, 2-alkyl and alcanol antifoam compounds. Preferred suds suppressing systems and antifoam compounds are disclosed in PCT Application No. WO93/08876 and EP-A-705 324.

Other Optional Ingredients

Other optional ingredients suitable for inclusion in the base powder of the invention include perfumes, optical brighteners, dye transfer inhibiting agents, and filler salts, with sodium sulfate being a preferred filler salt.

### EXAMPLES

All percentages are on a weight basis unless otherwise specified

TABLE 1

| Binder¹ | A | B | C | D |
|---|---|---|---|---|
| Sorbitol | 2.4 | 2.8 | 1.88 | 2.7 |
| Water | 0 | 0 | 0.12 | 0.25 |
| Glycerin | 0 | 0.4 | 0 | 0.25 |

¹Values given in table 1 are percentages by weight of the total detergent tablet.

TABLE 2

| Base powder ingredients² | E | F |
|---|---|---|
| Anionic/Cationic agglomerates³ | 35 | 35 |
| Anionic Agglomerates⁴ | 1.5 | — |
| Nonionic agglomerates⁵ | 12 | 4.50 |
| Clay extrudate⁶ | — | 8 |
| Layered Silicate⁷ | 1 | 2 |
| Sodium Percarbonate | 10 | 15 |
| Bleach activator agglomerates 1⁸ | 4 | — |
| Bleach activator agglomerates 2⁹ | — | 3 |
| Sodium Carbonate | 12 | 12 |
| EDDS/Sulphate particle¹⁰ | 0.6 | 0.2 |
| Tetrasodium salt of Hydroxyethane | 0.5 | 0.3 |
| Diphosphonic acid | | |
| Soil Release Polymer | 6 | 2.5 |
| Fluorescer | 0.1 | 0.1 |
| Zinc Phthalocyanide sulphonate | 0.05 | 0.01 |
| encapsulate¹¹ | | |
| Suds supressor¹² | 2 | 1.5 |
| Soap | — | 0.8 |
| Citric acid | 3 | 4 |
| Sodium Citrate | 3 | 2 |
| Sodium Acetate | 4 | 3 |
| Protease | 0.5 | 0.3 |
| Amylase | 0.2 | 0.05 |
| Cellulase | — | 0.1 |
| Perfume | 0.6 | 1 |
| Miscellaneous | to 100% | to 100%. |

²Values given in table 2 are percentages by weight of the total detergent tablet.
³Anionic/Cationic agglomerates comprise from 20% to 45% anionic surfactant, from 0.5% to 5% cationic surfactant, from 0% to 5% TAE80, from 15% to 30% SKS6, from 10% to 25% Zeolite, from 5% to 15% Carbonate, from 0% to 5% Carbonate, from 0% to 5% Sulphate, from 0% to 5% Silicate and from 0% to 5% Water.
⁴Anionic agglomerates comprise from 40% to 80% anionic surfactant and from 20% to 60% DIBS.
⁵Nonionic agglomerates comprise from 20% to 40% nonionic surfactant, from 0% to 10% polymer, from 30% to 50% Sodium Acetate anhydrous, from 15% to 25% Carbonate and from 5% to 10% zeolite.
⁶Clay agglomerates comprise from 90% to 100% of CSM Quest 5A clay, from 0% to 5% alcohol or diol, and from 0% to 5% water.
⁷Layered silicate comprises from 90% to 100% SKS6 and from 0% to 10% silicate.
⁸Bleach activator agglomerates 1 comprise from 65% to 75% bleach activator, from 10% to 15% anionic surfactant and from 5% to 15% sodium citrate.
⁹Bleach activator agglomerates 2 comprises from 75% to 85% TAED, from 15% to 20% acrylic/maleic copolymer (acid form) and from 0% to 5% water.
¹⁰Ethylene diamine N,N-disuccinic acid sodium salt/Sulphate particle comprises from 50% to 60% ethylene diamine N,N-disuccinic acid sodium salt, from 20% to 25% sulphate and from 15% to 25% water.
¹¹Zinc phthalocyanine sulphonate encapsulates are from 5% to 15% active.
¹²Suds suppressor comprises from 10% to 15% silicone oil (ex Dow Corning), from 50% to 70% zeolite and from 20% to 35% water.

### Example 1

i) Binder A was prepared by heating sorbitol to 105° C. in a 250 ml beaker (Duran® from Schott Glass/Germany) using a laboratory hot plate supplied from IKA Labortechnik.

ii) Base powder E was prepared by mixing the ingredients of base powder E shown in table 2, in a concrete mixing drum (supplied by LESCHA) at atmospheric pressure and ambient temperatures.

iii) 2.4 g of molten binder A from step i) was sprayed onto 97.6 g of base powder E from step ii) at a temperature of 105° C. at a pressure of 200 kPa to form a composition.

iv) The composition was allowed to cool down to a temperature of 25° C. and then tableted using a GEPA press. 40 g of composition is introduced in a 41·41 mm square die, and the composition is pressed to obtain detergent tablet having a hardness of 63.74 N as indicated in a VK200 tablet hardness tester (supplied by Van Kell Industries, Inc.).

### Example 2

i) Binder B was prepared by mixing 28 g of solid sorbitol with 4 g of glycerin before heating the mixtures up to 105° C. in a 250 ml beaker (Duran® from Schott Glass/Germany) using a laboratory hot plate supplied from IKA Labortechnik. The resulting liquid mixture was stirred for 10 minutes.

ii) Base powder F was prepared by mixing the ingredients of base powder F shown in table 2, in a concrete mixing drum (supplied by LESCHA) at atmospheric pressure and ambient temperatures.

iii) 3.2 g of molten binder B from step i) was sprayed onto 96.8 g base powder F from step ii) at a temperature of 105° C. at a pressure of 200 kPa to form a composition.

iv) The composition was allowed to cool down to a temperature of 25° C. and then tableted as under example 1, iv).

### Example 3

i) Binder C was prepared by mixing 18.8 g solid sorbitol with 1.2 g of water before heating the mixture up to 105° C. in a 250 ml beaker (Duran® from Schott Glass/Germany) using a laboratory hot plate supplied from IKA Labortechnik. The resulting liquid mixture was stirred for 10 minutes.

ii) Base powder E was prepared as under example 1, ii).

iii) 2.0 g of molten binder C from step i) was sprayed onto 98.0 g of base powder E from step ii) at a temperature of 105° C. at a pressure of 200 kPa to form a composition.

iv) The composition was allowed to cool down to a temperature of 25° C. and then tableted as under example 1, iv).

### Example 4

i) Binder D was prepared by mixing 27 g of solid sorbitol with 2.5 g of water and 2.5 g of glycerin before heating the mixture up to 105° C. in a 250 ml beaker (Duran® from Schott Glass/Germany) using a laboratory hot plate supplied from IKA Labortechnik. The resulting liquid mixture was stirred for 10 minutes.

ii) Base powder F was prepared as under example 2, ii).

iii) 3.2 g of molten binder D from step i) was sprayed onto 96.8 g of base powder F from step ii) at a temperature of 105° C. at a pressure of 200 kPa to form a composition.

iv) The composition was allowed to cool down to a temperature of 25° C. and then tableted as under example 1, iv).

### Example 5

Detergent tablets weighing 40 g each, are prepared according to examples 1 and 3. The detergent tablets are coated with a coating material comprising adipic acid and PG-2000Ca. 2.5 g of coating material is applied to each detergent tablet.

The coating material is prepared by mixing 95 g adipic acid with 5 g ion exchange resin such as PG-2000Ca supplied by Purolite, at a temperature of 160° C.

1. A process for making a detergent tablet, comprising the steps of:
(a) selecting a binder from the group consisting of: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof;
(b) heating the binder to above its melting point to form a molten binder;
(c) applying the molten binder to a base powder comprising a premix of detergent components, to form a detergent composition; and
(d) forming the detergent composition into tablets.

2. A process according to claim 1 whereby the binder is selected from sorbitol; xylitol; erythritol; nonylphenol, 50 ethoxylate; C₁₆-C₂₂ alcohol, 80 ethoxylate; castor oil, 160 ethoxylate; glyceryl tripalmitin ester; stearic acid; C₁₆-C₁₈ alcohol, 80 ethoxylate; C₁₃-C₁₅-alcohol, 30 ethoxylate, and mixtures thereof.

3. A process according to any of the preceding claims whereby the binder is sorbitol.

4. A process according to any of the preceding claims whereby the binder is mixed with one or more additional components selected from the group consisting of: viscosity modifiers, dissolution aids, surfactants, alkalinity sources, colorants, perfumes, crystal growth inhibitors, and combinations thereof.

5. A process according to any of the preceding claims whereby the binder is mixed with a viscosity modifier.

6. A process according to claims 4 or 5, whereby the viscosity modifier is present at a concentration of from 1.0% to 95%, more preferably from 2.5% to 50%, even more preferably from 5.0% to 15%, and most preferably from 7.5 to 12.5% by weight of the binder system.

7. A process according to any of the preceding claims whereby the binder is sprayed onto the base powder.

8. A process according to any preceding claims further comprising step (e):
(e) coating the detergent tablet with a coating material.

9. A tablet composition obtainable by a process according to any of the preceding claims.

10. A coated tablet composition obtainable by a process according to claim 8.

11. The use of a binder in its molten form for improving the resistance to breakage of detergent tablets, whereby the binder is selected from the group consisting of: sorbitol, xylitol, erythritol, C₁₀-C₁₈ phenol alkoxylates with 20 to 80 equivalents of alkoxylation; C₁₂-C₂₄ alcohol alkoxylates with 50 to 250 equivalents of alkoxylation; castor oil alkoxylates with 50 to 100 equivalents of alkoxylation; mono-, di- and/or tri-esters of glycerin with C₁₂-C₂₅ fatty acids; C₁₀ to C₂₅ fatty acids; and mixtures thereof.
